(19) United States
(12) Patent Application Publication
(10) Pub. No.: US 2006/0182175 A1
(43) Pub. Date: Aug. 17, 2006

(54) Image encoding apparatus, image encoding method, and computer program product

(75) Inventor: Reiko Noda, Kanagawa (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/327,358

(22) Filed: Jan. 9, 2006

(30) Foreign Application Priority Data
Feb. 14, 2005 (JP) 2005-36208

(51) Int. Cl. H04N 11/04; H04B 1/66; H04N 11/02; H04N 7/12

(52) U.S. Cl. 375/240.03

(57) ABSTRACT

An image encoding apparatus includes an image obtaining unit configured to obtain an image from outside; a tentative encoder that performs a tentative encoding of the image in a predetermined quantization step; an encoding error calculator that calculates an encoding error between a tentative encoded image and the image obtained by the image obtaining unit; a vision threshold calculator that calculates a vision threshold, which is a threshold of the encoding error, at which an image deterioration of an encoded image might be recognized by human vision, based on an image characteristic amount of the image obtained by the image obtaining unit; a quantization step width changer that changes the quantization step width when the encoding error is a value out of range of the vision threshold, which is the predetermined range not larger than the vision threshold; and an encoder that performs an encoding of the image in a changed quantization step.

### CROSS-REFERENCE TO RELATED APPLICATIONS

This application is based upon and claims the benefit of priority from the prior Japanese Patent Application No. 2005-036208, filed on Feb. 14, 2005; the entire contents of which are incorporated herein by reference.

### BACKGROUND OF THE INVENTION

1. Field of the Invention

The present invention relates to an image encoding apparatus, an image encoding method, and a computer program product, for performing an image encoding with a predetermined quantization step width.

2. Description of the Related Art

In a standard method of encoding a motion image, such as ITU-T H. 264, and ISO/IEC MPEG-2, high-quality image compression is possible by selecting an optimal encoding mode and a quantization parameter, according to characteristics of each encoding unit, called a macroblock. Specifically, it has been attempted to improve encoding efficiency and image quality by minimizing the quantization step relative to the block, judged to be important, and enlarging the quantization step relative to the block judged to be less important, in most basic quantization means of the compression method.

For example, a modification method of the quantization step in view of vision characteristics has been introduced in TM5 (International Organization for Standardisation, Test Model Editing Committee, 1933. Test Model 5. April. ISO-IEC/JTC1/SC29/WG11/N0400), which was a test model of the ISO/IEC MPEG-2. The method is to divide an input image into the macroblocks in view of characteristics in which the human vision is sensitive to a distortion of a flat part, thereby modifying a value of the quantization step in the flat part having low activity, to a relatively small value, by calculating a minimum value of luminance dispersion of pixels of four sub blocks in the macroblock, called activity.

### SUMMARY OF THE INVENTION

According to one aspect of the present invention, an image encoding apparatus includes an image obtaining unit configured to obtain an image from outside; a tentative encoder that performs a tentative encoding of the image in a predetermined quantization step; an encoding error calculator that calculates an encoding error between a tentative encoded image and the image obtained by the image obtaining unit; a vision threshold calculator that calculates a vision threshold, which is a threshold of the encoding error, at which an image deterioration of an encoded image might be recognized by human vision, based on an image characteristic amount of the image obtained by the image obtaining unit; a quantization step width changer that changes the quantization step width when the encoding error is a value out of range of the vision threshold, which is the predetermined range not larger than the vision threshold; and an encoder that performs an encoding of the image in a changed quantization step.

According to another aspect of the present invention, an image encoding method includes obtaining an image from outside; performing a tentative encoding of the image in a predetermined quantization step; calculating an encoding error between a tentative encoded image and the image obtained; calculating a vision threshold, which is a threshold of the encoding error, at which an image deterioration of an encoded image might be recognized by human vision, based on an image characteristic amount of the image obtained; changing the quantization step width when the encoding error is a value out of range of the vision threshold, which is the predetermined range not larger than the vision threshold; and performing an encoding of the image in a changed quantization step.

According to still another aspect of the present invention, a computer program product has a computer readable medium including programmed instructions for an image coding processing. The instructions, when executed by a computer, cause the computer to perform obtaining an image from outside; performing a tentative encoding of the image in a predetermined quantization step; calculating an encoding error between a tentative encoded image and the image obtained; calculating a vision threshold, which is a threshold of the encoding error, at which an image deterioration of an encoded image might be recognized by human vision, based on an image characteristic amount of the image obtained; changing the quantization step width when the encoding error is a value out of range of the vision threshold, which is the predetermined range not larger than the vision threshold; and performing an encoding of the image in a changed quantization step.

### BRIEF DESCRIPTION OF THE DRAWINGS

FIG. 1 is an overall block diagram showing the function and structure of an image encoding apparatus according to a first embodiment;

FIG. 2 is a block diagram showing the function and structure of a quantization controller in detail;

FIG. 3 is a graph showing a relationship between edge strength (EAN) in equation (1) and a threshold level of perceptual distortion (SAD_{D});

FIG. 4 is a block diagram showing the function and structure of an encoder in detail;

FIG. 5 is a flowchart showing a quantization controlling process by the quantization controller;

FIG. 6 is a view to explain the quantization controlling process in detail;

FIG. 7 is a view showing a hardware structure of the image encoding apparatus according to the first embodiment;

FIG. 8 is a block diagram showing an entire structure of the image encoding apparatus according to a second embodiment;

FIG. 9 is a graph showing a relationship between a standard quantization step width and the threshold level of perceptual distortion (SAD_{D});

FIG. 10 is a flowchart showing the quantization controlling process by the quantization controller according to the second embodiment;

FIG. 11 is a graph showing a relationship between an initial quantization step width and a coefficient α; and

FIG. 12 is a view to explain more specifically the quantization controlling process.

### DETAILED DESCRIPTION OF THE INVENTION

Exemplary embodiments of an image encoding apparatus, an image encoding method, and a computer program product according to the present invention will be described in detail below with reference to the accompanying drawings. The present invention is not restricted to these embodiments.

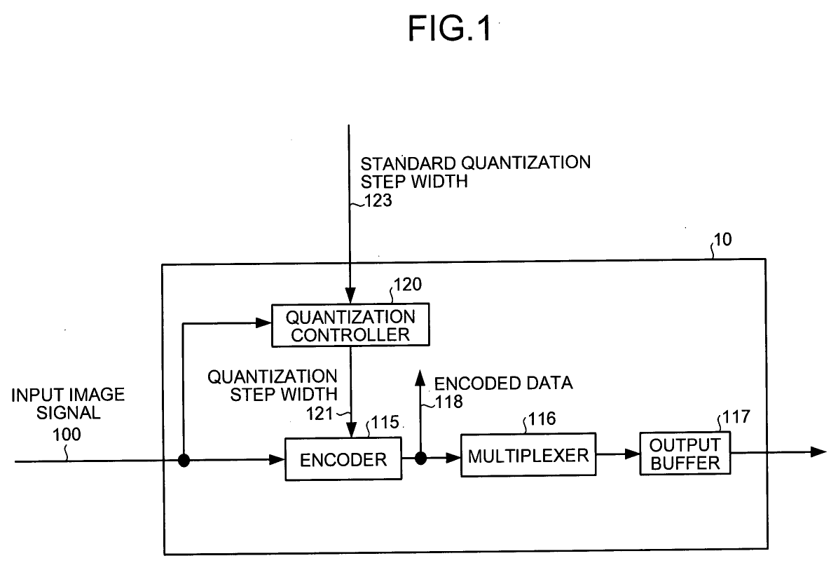

FIG. 1 is an overall block diagram showing the function and structure of an image encoding apparatus 10 according to a first embodiment. The image encoding apparatus 10 is provided with an encoder 115, a multiplexer 116, an output buffer 117, and a quantization controller 120.

The encoder 115 obtains an image signal, for example, in frame, as an input image signal 100, and performs an entropy encoding of the image signal. Each code generated by the entropy encoding is outputted as encoded data 118.

The encoded data 118 is multiplied at the multiplexer 116, and is smoothed by the output buffer 117. Thus, the encoded data outputted from the output buffer 117 is sent to a transmission system or an accumulation system not shown.

The quantization controller 120 controls the encoder 115. Specifically, the controller 120 obtains a standard quantization step width 123, which is an initial value of the quantization step width, from outside. Furthermore, the controller 120 analyzes the input image signal 100 to determine the quantization step width so as to make encoding distortion, that is, an encoding error, not more than a threshold level of perceptual distortion. Further, the controller 120 outputs a determined quantization step width 121 to the encoder 115, thereby making the encoder 115 perform an encoding process with the quantization step width. As used herein, the term “threshold level of perceptual distortion” means a boundary value at which the encoding error might be recognized by the human vision.

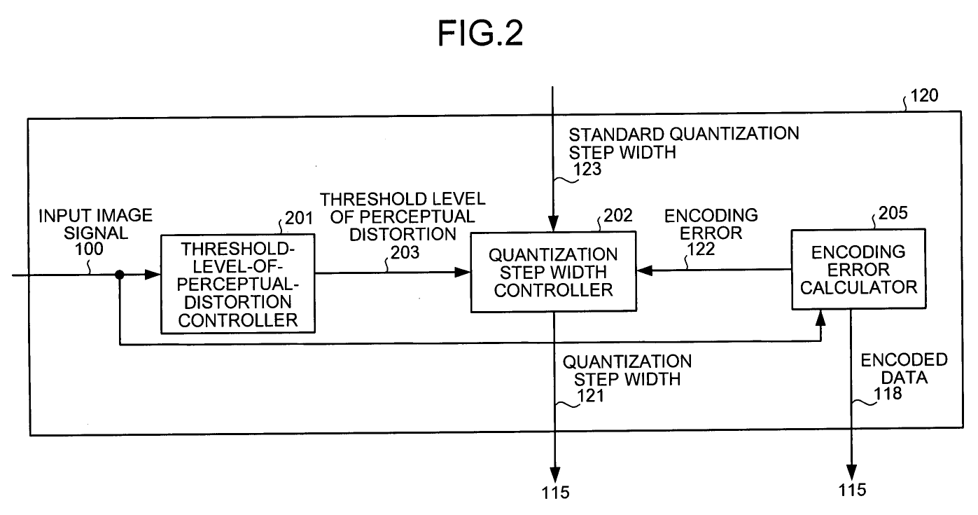

FIG. 2 is a block diagram showing the function and structure of the quantization controller 120 in detail. The quantization controller 120 comprises a threshold-level-of-perceptual-distortion calculator 201, a quantization step controller 202, and an encoding error calculator 205.

The threshold-level-of-perceptual-distortion calculator 201 divides the input image signal 100, e.g. in frame, into e.g. macroblocks. Further, the calculator 201 calculates a threshold level of perceptual distortion 203 of each of the macroblocks. As used herein, the threshold level of perceptual distortion 203 is a value corresponding to image deterioration to the human vision. That is to say, when the value of the encoding error becomes larger than that of the threshold level of perceptual distortion 203, the image deterioration, which might be recognized by the human vision, occurs.

The threshold level of perceptual distortion according to this embodiment may be referred to as a vision threshold. The threshold-level-of-perceptual-distortion calculator 201 according to this embodiment may be referred to as a vision threshold calculator.

Specifically, the threshold level of perceptual distortion 203 is calculated by equations (1) and (2):
d=α×log(EAN)+β (1)
SAD_{D}=exp(d) (2)
where SAD_{D} represents the threshold level of perceptual distortion 203, and EAN represents edge strength in the macroblock, which is a process object.

The edge strength is calculated by a following process. That is, an average value of the edge strength of each pixel within the macroblock, which is the process object, is calculated. Then, the edge strength of each of the macroblocks is normalized to range from 0 to 1, while setting the maximum value of the average value of the edge strength of each macroblock included in the frame to 1. In this embodiment, the average value of the edge strength of each pixel in the macroblock is called the edge strength.

Herein, α and β are positive constants. For example, these are values experimentally found from a value of the encoding distortion, when the distortion is perceived while actually encoding the image.

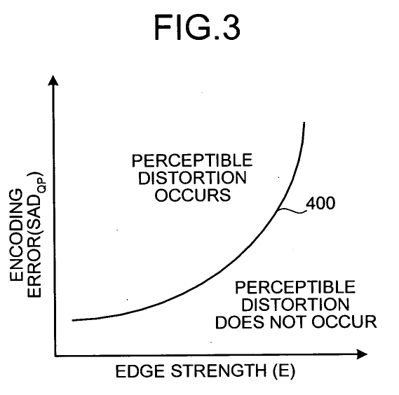

FIG. 3 is a graph showing a relationship between the edge strength (EAN) in the equation 1 and the threshold level of perceptual distortion (SAD_{D}). A curved line 400 as shown in FIG. 3 indicates the threshold level of perceptual distortion (SAD_{D}). As shown in the graph in FIG. 3, the larger the edge strength is, that is, the smaller the edge of the macroblock is, the larger the threshold level of perceptual distortion (SAD_{D}) is.

Then, the image deterioration, which is recognized by the human vision, can be reduced by changing the quantization step width such that an encoding error (SAD_{QP}) becomes smaller than the threshold level of perceptual distortion (SAD_{D}) indicated by the curved line 400.

The device in FIG. 2 is described again. The encoding error calculator 205 obtains the encoded data 118 from the encoder 115, and the input image signal 100 from outside. Then, the calculator 205 calculates the encoding error (SAD_{QP}) based on the input image signal 100 and the encoded data 118. An encoding error 122 is outputted to the quantization step controller 202.

In this embodiment, the encoding error calculator 205 calculates a sum of absolute difference between a current image and an encoded image as the encoding error (SAD_{QP}). The encoding error (SAD_{QP}) is not restricted to the sum of absolute difference, but may also be an absolute squared error.

The quantization step controller 202 makes the encoder 115 perform the encoding process with the standard quantization step width 123. Further, the quantization step controller 202 obtains the threshold level of perceptual distortion 203 and the encoding error 122. Then, the quantization step controller 202 changes a value of the quantization step width 121 until the encoding error 122 becomes smaller than the threshold level of perceptual distortion 203, thereby making the encoder 115 perform the encoding process with a changed quantization step width.

The quantization step controller 202 of this embodiment may be referred to as a quantization step width changer.

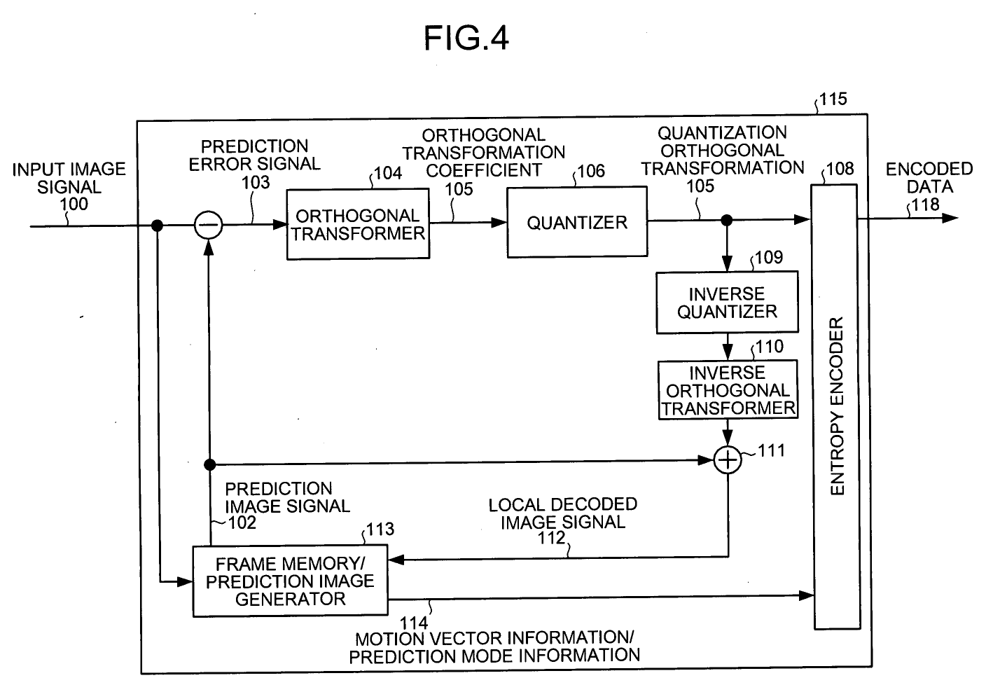

FIG. 4 is a block diagram showing the function and structure of the encoder 115 in detail. The encoder 115 comprises a subtracter 101, an orthogonal transformer 104, a quantizer 106, an entropy encoder 108, an inverse quantizer 109, an inverse orthogonal transformer 110, an accumulator 111, and a frame memory/prediction image generator 113.

The subtracter 101 calculates a difference between the input image signal 100 and a prediction image signal 102, thereby generating a prediction error signal 103.

The orthogonal transformer 104 performs an orthogonal transformation, for example, a discrete cosine transform to the generated prediction error signal 103. A quantization orthogonal transformation coefficient 105, for example, DCT coefficient information, is obtained at the orthogonal transformer 104.

The quantizer 106 quantizes the quantization orthogonal transformation coefficient 105 to obtain a quantization orthogonal transformation coefficient 107. The quantization orthogonal transformation coefficient 107 is outputted to both the entropy encoder 108 and the inverse quantizer 109.

The quantization orthogonal transformation coefficient 107 is performed processes, which are opposite processes of those of the quantizer 106 and the orthogonal transformer 104 by the inverse quantizer 109 and the inverse orthogonal transformer 110, so as to be made to a signal similar to the prediction error signal 103, and is sent to the accumulator 111. The accumulator 111 adds the signal inputted from the inverse orthogonal transformer 110 and the prediction image signal 102 to generate a local decoded image signal 112. The local decoded image signal 112 is inputted to the frame memory/prediction image generator 113.

The frame memory/prediction image generator 113 generates the prediction image signal based on prediction mode information, from the input image signal 100 and the local decoded image signal 112. Specifically, the frame memory/prediction image generator 113 accumulates the local decoded image signal 112 from the accumulator 111. Then the generator 113 performs a matching (e.g. a block matching) between the input image signal 100 and the local decoded image signal 112 accumulated in the frame memory/prediction image generator 113, in each block within the frame, and detects a motion vector. Further the generator 113 generates the prediction image signal by using the local image signal compensated by the motion vector.

The prediction image signal 102 generated at the frame memory/prediction image generator 113 is outputted from the same with motion vector information/prediction mode information 114 of a selected prediction image signal.

The entropy encoder 108 performs the entropy encoding based on the quantization orthogonal transformation coefficient 107 and the motion vector information/prediction mode information 114. While the entropy encoder 108 according to this embodiment performs the encoding in macroblocks, this may perform the encoding in another unit.

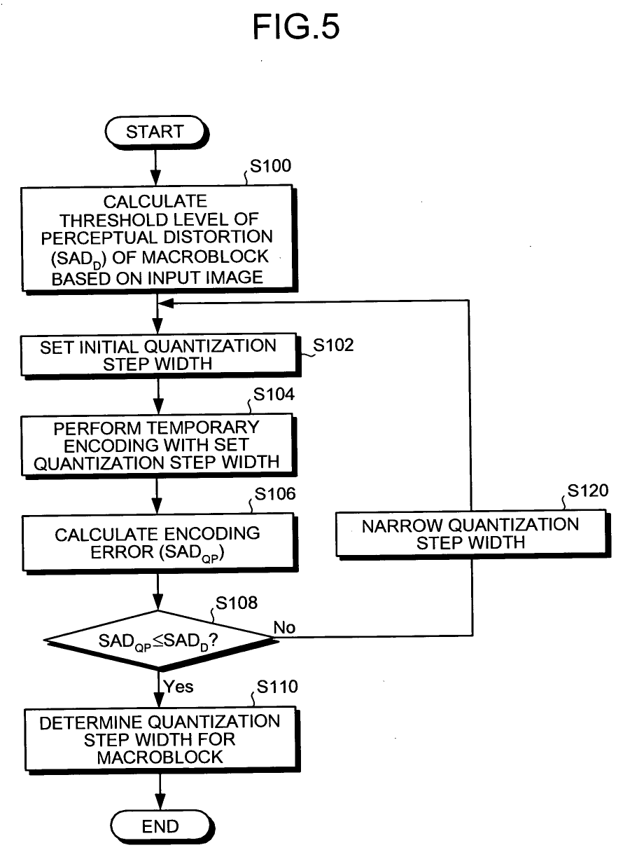

FIG. 5 is a flowchart showing a quantization controlling process by the quantization controller 120. The quantization controller 120 first obtains the input image signal 100. Then, the controller 120 calculates the threshold level of perceptual distortion 203 of the macroblock based on the obtained input image signal 100 (step S100).

Next, the quantization controller 120 determines the standard quantization step width 123 obtained from outside as the quantization step width of a tentative encoding (step S102). Further, the encoder 115 performs the tentative encoding with the determined quantization step width (step S104). Then, the encoding error (SAD_{QP}) in the tentative encoding is calculated (step S106).

Next, the encoding error (SAD_{QP}) and the threshold level of perceptual distortion (SAD_{D}) are compared to each other. When the encoding error (SAD_{QP}) is not less than the threshold level of perceptual distortion (SAD_{D}) (step S108, No), the quantization step width is narrowed by a predetermined amount (step S120). Further, the encoder 115 performs the tentative encoding again with the quantization step width changed at step S120 (step S104).

The process from step S104 to step S120 is repeated until the encoding error (SAD_{QP}) becomes smaller than the threshold level of perceptual distortion (SAD_{D}) (step S108: Yes).

When the encoding error (SAD_{QP}) becomes smaller than the threshold level of perceptual distortion (SAD_{D}) by the quantization controlling process, the quantization step width at that time is determined as the quantization step width in relation to the macroblock concerned (step S110). Then, the quantization controlling process ends.

Further, the encoder 115 outputs a result encoded with the quantization step width determined by the quantization controlling process. In this manner, the image deterioration, which might be recognized by the human vision, can be reduced by encoding with a smaller quantization step width than the threshold level of perceptual distortion (SAD_{D}).

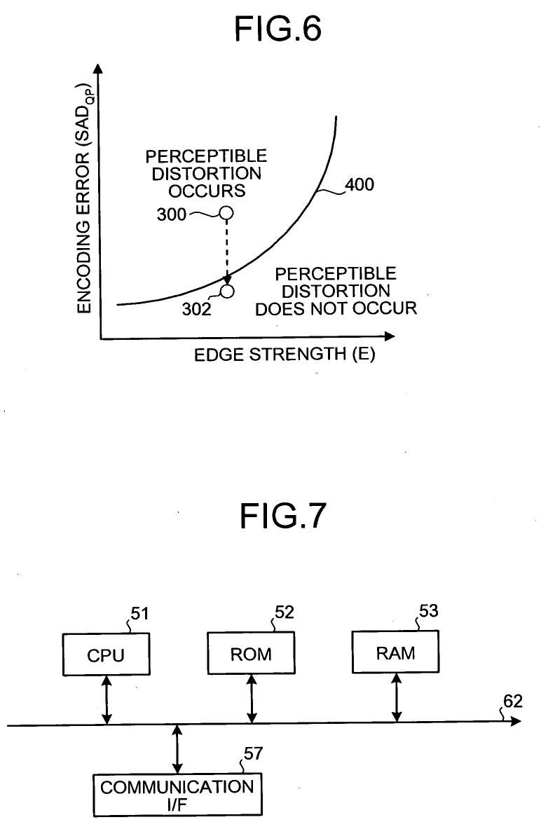

FIG. 6 is a view to explain the quantization controlling process in detail. As shown in FIG. 6, the distortion which might be recognized by the human vision is generated due to encoding, when a value of the encoding error (SAD_{QP}) is not less than that of the threshold level of perceptual distortion (SAD_{D}). In this case, it is required to reduce the distortion. So, the quantization step width is narrowed by the predetermined amount at step S120. By repeating the process until the encoding error (SAD_{QP}) becomes smaller than the threshold level of perceptual distortion (SAD_{D}), the quantization step width can be narrowed so as not to generate the distortion which might be recognized by the human vision, that is, to make the encoding error (SAD_{QP}) smaller than the threshold level of perceptual distortion (SAD_{D}).

While the process in which the quantization step width is narrowed by the predetermined amount to perform the encoding until the encoding error (SAD_{QP}) becomes smaller than the threshold level of perceptual distortion 203, is repeated in this embodiment, the method is not limited to this embodiment, provided that the quantization step width to make the encoding error (SAD_{QP}) smaller than the threshold level of perceptual distortion 203 can be determined.

FIG. 7 is a view showing a hardware structure of the image encoding apparatus 10 according to the first embodiment. The image encoding apparatus 10 is provided with a ROM 52 in which an image encoding program or the like to execute an image encoding process at the image encoding apparatus 10, a CPU 51 to control each element of the image encoding apparatus 10 according to the program in the ROM 52, a RAM 53 to store various date required for controlling the image encoding apparatus 10, a communication I/F 57 to communicate by being connected to a network, and a bus 62 to connect each of the elements.

The image encoding program in the aforementioned image encoding apparatus 10 is a program including a quantization control program for executing the quantization controlling process characteristics to this embodiment. The image encoding program may be stored in a recording media capable of being read by a computer, such as a CD-ROM, a Floppy (trademark) Disk (FD), a DVD or the like, and provided as a file capable of being installed or executed.

In this case, the image encoding program is read from the above-described recording media and executed at the image encoding apparatus 10 to be loaded on a main memory, and each of the elements explained in the above-described software structure is generated on the main memory.

Further, the image encoding program according to this embodiment may be stored on the computer connected to the network such as an Internet or the like, to be provided by being downloaded through the network.

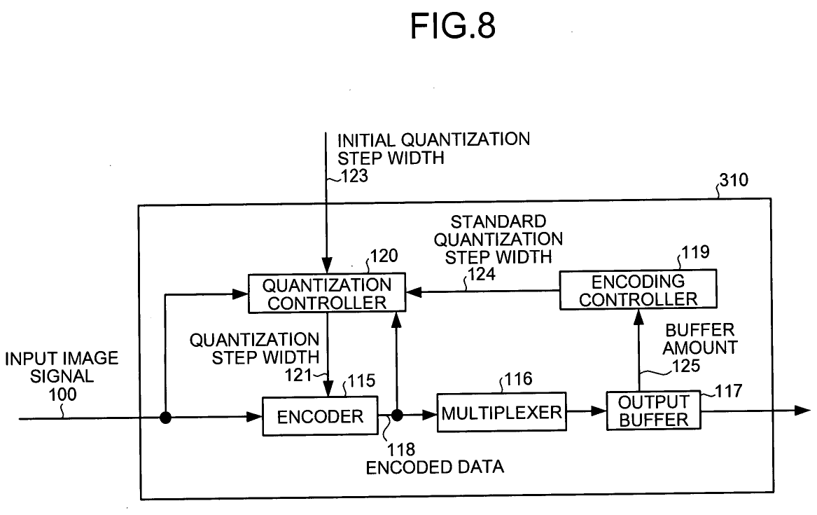

FIG. 8 is a block diagram showing an entire structure of the image encoding apparatus 310 according to a second embodiment. The image encoding apparatus 310 according to the second embodiment further comprises an encoding controller 119 in addition to the structure of the image encoder according to the first embodiment.

The encoding controller 119 monitors a buffer amount 125 of the output buffer 117. Further the controller 119 assigns an encoding amount for each encoding unit, based on the buffer amount. Further the controller 119 outputs a standard quantization step width 124, which is a step width according to the assigned encoding amount, to the quantization controller 120. The encoding controller 119 according to this embodiment may be referred to as a data amount monitor or a quantization step width determiner.

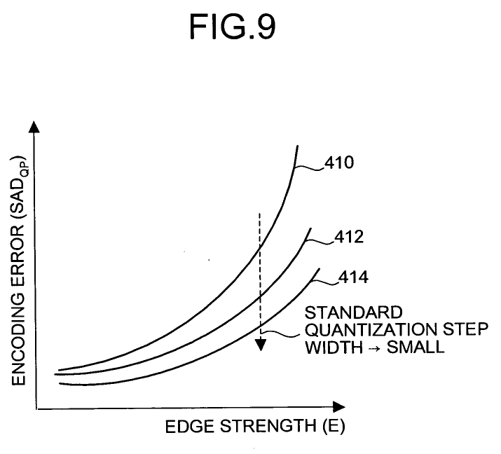

FIG. 9 is a graph showing a relationship between the standard quantization step width and the threshold level of perceptual distortion (SAD_{D}). Curved lines 410, 412, and 414 in FIG. 9 each indicate the threshold level of perceptual distortion (SAD_{D}). As shown in FIG. 9, the threshold level of perceptual distortion (SAD_{D}) becomes smaller from the curved line 410 to the curved line 414, as the standard quantization step width becomes smaller.

When the encoding amount assigned to the encoding unit is large, the encoding controller 119 sets the standard quantization step width to be narrow. Therefore, the threshold level of perceptual distortion (SAD_{D}) becomes small. That is to say, it becomes possible to reduce the image deterioration, which might be recognized by the human vision. On the other hand, when the encoding amount assigned to the encoding unit is small, the standard quantization step width is set to be wide. Therefore, the threshold level of perceptual distortion becomes large.

In this manner, it is possible to determine a value of the threshold level of perceptual distortion (SAD_{D}) by the standard quantization step width 124 determined based on the encoding amount assigned by the encoding controller 119. Further, the encoding amount is determined based on the buffer amount. That is to say, the value of the threshold level of perceptual distortion (SAD_{D}) can be determined based on the buffer amount.

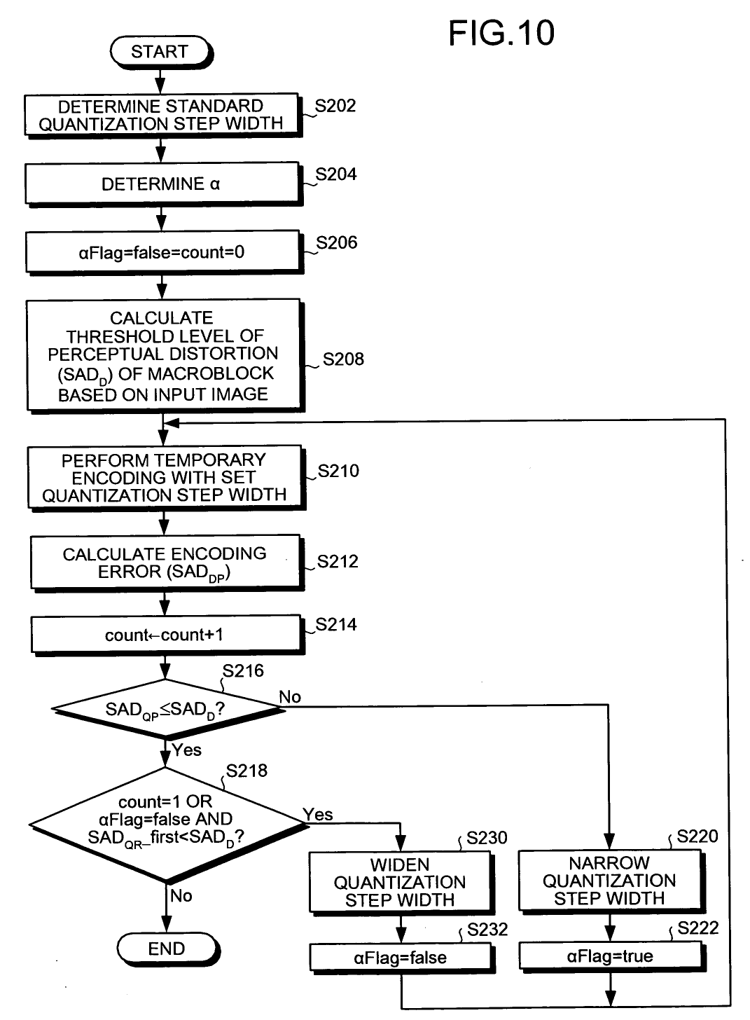

FIG. 10 is a flowchart showing a quantization controlling process by the quantization controller 120 according to this embodiment. The encoding controller 119 first determines the standard quantization step width based on the buffer amount 125 (step S202). Next, the quantization controller 120 determines a value of a coefficient α in equation (1) for calculating the threshold level of perceptual distortion (SAD_{D}), based on the input image signal 100 and the standard quantization step width 124 (step S204).

Specifically, the coefficient α is calculated by equation (3):
α=a×QP_first+b (3)
where QP_first represents the standard quantization step width.

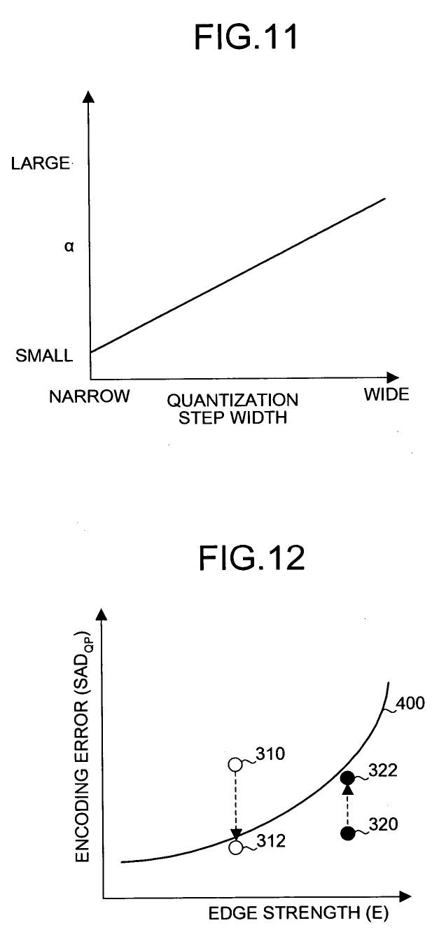

FIG. 11 is a graph showing a relationship between the standard quantization step width and the coefficient α. In this way, as the standard quantization step width becomes wider, the value of the coefficient α becomes larger, consequently, the threshold level of perceptual distortion (SAD_{D}) calculated by equations (1) and (2) becomes larger.

In the coefficients α and β of the equations for calculating the threshold level of perceptual distortion (SAD_{D}) the coefficient β is set to a fixed value and the coefficient α is made to vary adaptively in this embodiment. The coefficient α may be set to the fixed value and the coefficient β may be made to vary adaptively as another example.

The flowchart in FIG. 10 is described again. When the value of coefficient α is determined, the quantization controller 120 sets a flag αFlag to false, and sets a count to 0 (step S206). Next, the quantization controller 120 calculates the threshold level of perceptual distortion (SAD_{D}) of the macroblock based on the input image signal 100 (step S208).

Next, the encoder 115 performs the tentative encoding with the quantization step width determined by the quantization controller 120, that is, the standard quantization step width (step S210). Then, the encoder 115 calculates the encoding error (SAD_{QP}) at the tentative encoding (step S212). Further, the encoder 115 increments the count by 1 (step S214).

Next, the encoding error (SAD_{QP}) and the threshold level of perceptual distortion (SAD_{D}) are compared to each other. When the encoding error (SAD_{QP}) is larger than the threshold level of perceptual distortion (SAD_{D}) (step S216: No), the quantization step width is narrowed by the predetermined amount (step S220). Further the αFlag is set to false (step S222). Further, the encoder 115 performs the tentative encoding again with a narrower quantization step width (step S210).

On the other hand, when the encoding error (SAD_{QP}) is not larger than the threshold level of perceptual distortion (SAD_{D}) (step S216: Yes), in a case in which the count is set to 1 or the αFlag is set to false and if the encoding error (SAD_{QP}_{_{—}}first) at the standard quantization step width is smaller than the threshold level of perceptual distortion (SAD_{D}) (step S218: Yes), the quantization step width is widened by a predetermined amount (step S230). Further the αFlag is set to false (step S232). Then, the encoder 115 performs the encoding again with a wider quantization step width (step S210).

Further, when the encoding error (SAD_{QP}) is not more than the threshold level of perceptual distortion (SAD_{D}) and the count is not set to 1 (step S218: No), or, when the encoding error (SAD_{QP}) is not more than the threshold level of perceptual distortion (SAD_{D}), the αFlag is set to false, and the encoding error (SAD_{QP}_{_{—}}first) at the initial quantization step width is not less than the threshold level of perceptual distortion (SAD_{D}) (step S128: No), the quantization controlling process ends. Then, the encoder 115 outputs the result encoded with the quantization step width determined by the quantization controlling process.

As described above, the quantization controlling process is repeated by increasing and decreasing the quantization step width such that the encoding error (SAD_{QP}) becomes smaller than the threshold level of perceptual distortion (SAD_{D}) and is set to a value as close as possible to the threshold level of perceptual distortion (SAD_{D}).

The quantization controlling process will be described more specifically with reference to FIG. 12. A point 310 in FIG. 12 indicates the encoding error (SAD_{QP}) with the initial quantization step width in a macroblock A. In this manner, in a case in which the encoding error (SAD_{QP}) when encoding with the initial quantization step parameter is larger than the threshold level of perceptual distortion (SAD_{D}), the quantization step width is reduced until the encoding error (SAD_{QP}) when encoding with the initial quantization parameter becomes smaller than the threshold level of perceptual distortion (SAD_{D}).

Furthermore, in the view of reducing the encoding amount, this is preferably set to a value as close as possible to the threshold level of perceptual distortion (SAD_{D}). That is to say, the quantization step width is preferably determined such that the encoding error (SAD_{QP}) is not larger than and the closest to the threshold level of perceptual distortion (SAD_{D}) as a point 312 in FIG. 12.

On the other hand, a point 320 in FIG. 12 indicates the encoding error (SAD_{QP}) with the standard quantization step width in a macroblock B. In this manner, in case in which the encoding error (SAD_{QP}) when performing the encoding with a standard quantization parameter is smaller than the threshold level of perceptual distortion (SAD_{D}), the quantization step width is determined such that the encoding error (SAD_{QP}) when performing the encoding with the standard quantization parameter becomes smaller than and the closest to the threshold level of perceptual distortion (SAD_{D}).

In this way, when the encoding error (SAD_{QP}) is smaller than the threshold level of perceptual distortion (SAD_{D}), the encoding amount can be restricted in a range within which the deterioration is hard to be recognized, by widening the quantization step width such that the encoding error (SAD_{QP}) becomes the closest value to the threshold level of perceptual distortion (SAD_{D}).

Furthermore, since the encoding amount is made smaller by widening the quantization step width, the quantization step width at another macroblock may be narrowed.

While the process was repeated by increasing and decreasing the quantization step by the predetermined amount so as to make the same be the closest value to the threshold level of perceptual distortion (SAD_{D}) in this embodiment, the method is not limited to this embodiment, provided that the quantization step becomes a value the closest to the threshold level of perceptual distortion (SAD_{D}).

Further, while the process was repeated by increasing and decreasing of the quantization step so as to make the same be smaller than and the closest to the threshold level of perceptual distortion (SAD_{D}) in this embodiment, an increasing and decreasing frequency of the quantization step may be limited to N times, in the view of a high-speed encoding.

In the first embodiment, the coefficients α and β in the equation 1 is uniquely set and the quantization step width is determined so as not to be larger than the threshold level of perceptual distortion (SAD) calculated by the equation 1, to perform the encoding with the quantization step width concerned, when calculating the threshold level of perceptual distortion, so that the encoding amount of an outputted encoding stream is different from each other according to characteristics of the image. On the other hand, in the quantization controlling process according to the second embodiment, the encoding amount can be controlled by adoptively changing the coefficients α and β of the equation 1 based on the standard quantization step width 124 given by the encoding controller 119. That is to say, the encoding amount can be controlled while reducing the encoding distortion, which might be recognized by the human vision.

While the present invention is described above referring to the embodiments, various modifications and improvements can be made to the above-described embodiments.

While the threshold level of perceptual distortion SAD is calculated from the average value of the edge strength in the macroblocks in this embodiment, this may be calculated by another means, for example, by using a luminance dispersion value of the macroblocks, as a first alternative.

Further, while the example in which the encoding unit is set to the macroblock and the pair of the prediction mode and the quantization parameter is determined in macroblocks, which is the encoding unit, is described in this embodiment, the encoding unit may be set to a plurality of macroblock units, slice, field, frame, picture, or GOP may be used, as a second alternative example.

Furthermore, while the quantization controlling process in a motion image encoding is described in this embodiment, the quantization controlling process may be applied to a still image encoding and a multiple viewpoint image encoding.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image encoding apparatus comprising:
an image obtaining unit configured to obtain an image from outside;
a tentative encoder that performs a tentative encoding of the image in a predetermined quantization step;
an encoding error calculator that calculates an encoding error between a tentative encoded image and the image obtained by the image obtaining unit;
a vision threshold calculator that calculates a vision threshold, which is a threshold of the encoding error, at which an image deterioration of an encoded image might be recognized by human vision, based on an image characteristic amount of the image obtained by the image obtaining unit;
a quantization step width changer that changes the quantization step width when the encoding error is a value out of range of the vision threshold, which is the predetermined range not larger than the vision threshold; and
an encoder that performs an encoding of the image in a changed quantization step.

2. The image encoding apparatus according to claim 1, wherein the quantization step width changer changes the quantization step width when the encoding error is larger than a maximum value of the range of the vision threshold.

3. The image encoding apparatus according to claim 2, wherein the quantization step width changer changes the quantization step width when the encoding error is smaller than a minimum value of the range of the vision threshold.

4. The image encoding apparatus according to claim 1, wherein the quantization step width changer changes the quantization step width such that the encoding error becomes a value within the range of the vision threshold.

5. The image encoding apparatus according to claim 1, wherein the vision threshold calculator calculates the vision threshold, based on edge strength, which is the image characteristic amount of the image.

6. The image encoding apparatus according to claim 5, wherein the vision threshold calculator calculates the vision threshold by
SAD=exp(α×EAN+β)
wherein SAD and EAN represent the vision threshold and the edge strength, respectively, and α and β represent optional constants.

7. The image encoding apparatus according to claim 6, further comprising:
a buffer that holds the encoded data encoded by the encoder; and
a data amount monitor that monitors a data amount of the encoded data held by the buffer,
wherein the vision threshold calculator determines at least one of the coefficients α and β, based on the data amount determined by the data amount monitor.

8. The image encoding apparatus according to claim 7, further comprising:
a quantization step width determiner that determines the quantization step width when the tentative encoding is performed based on the data amount monitored by the data amount monitor, wherein
the vision threshold calculator determines at least one of the coefficients α and β, based on a determined quantization step width.

9. The image encoding apparatus according to claim 1, wherein the encoding means performs an encoding of the image with the changed quantization step.

10. The image encoding apparatus according to claim 1, wherein the vision threshold calculator calculates the vision threshold based on a luminance dispersion value, which is the image characteristic amount.

11. An image encoding method comprising:
obtaining an image from outside;
performing a tentative encoding of the image in a predetermined quantization step;
calculating an encoding error between a tentative encoded image and the image obtained;
calculating a vision threshold, which is a threshold of the encoding error, at which an image deterioration of an encoded image might be recognized by human vision, based on an image characteristic amount of the image obtained;
changing the quantization step width when the encoding error is a value out of range of the vision threshold, which is the predetermined range not larger than the vision threshold; and
performing an encoding of the image in a changed quantization step.

12. A computer program product having a computer readable medium including programmed instructions for an image coding processing, wherein the instructions, when executed by a computer, cause the computer to perform:
obtaining an image from outside;
performing a tentative encoding of the image in a predetermined quantization step;
calculating an encoding error between a tentative encoded image and the image obtained;
calculating a vision threshold, which is a threshold of the encoding error, at which an image deterioration of an encoded image might be recognized by human vision, based on an image characteristic amount of the image obtained;
changing the quantization step width when the encoding error is a value out of range of the vision threshold, which is the predetermined range not larger than the vision threshold; and
performing an encoding of the image in a changed quantization step.
